(19) United States
(12) Patent Application Publication
(10) Pub. No.: US 2022/0083508 A1
(43) Pub. Date: Mar. 17, 2022

(54) TECHNIQUES FOR INTUITIVE VISUALIZATION AND ANALYSIS OF LIFE SCIENCE INFORMATION

(71) Applicant: Seattle Biosoftware, Inc., Seattle, WA (US)

(72) Inventor: Peter Askovich, Seattle, WA (US)

(73) Assignee: Seattle Biosoftware, Inc., Seattle, WA (US)

(21) Appl. No.: 17/476,238

(22) Filed: Sep. 15, 2021

Related U.S. Application Data
(60) Provisional application No. 63/079,835, filed on Sep. 17, 2020.

(51) Int. Cl. G06F 16/14; G06F 16/16

(52) U.S. Cl. CPC G06F 16/148; G06F 16/164

(57) ABSTRACT

In some embodiments, a method for processing life science information is provided. A plurality of files are stored in a file data store. Each file of the plurality of files is associated with one or more tags. A plurality of object definitions and a plurality of action definitions are stored. A selection of an object definition of the plurality of object definitions is received. One or more files are retrieved from the file data store that are identified by the selected object definition. A selection of an action definition of the plurality of action definitions is received. An action defined by the selected action definition is performed on the one or more files retrieved from the file data store.

### CROSS-REFERENCE(S) TO RELATED APPLICATION(S)

This application claims the benefit of Provisional Application No. 63/079835, filed Sep. 17, 2020, the entire disclosure of which is hereby incorporated by reference herein for all purposes.

### BACKGROUND

The biggest asset that Life Science companies have are their scientists. In this day and age, it is very common for scientists to specialize to a very narrow field. As such, they often become experts in that system and their insight and thinking is indispensable. Experts in those narrow fields, however, are often not also experts in bioinformatics and data analysis. Therefore, it is desirable to allow scientists to intuitively manipulate, visualize and analyze data so that they may apply their full knowledge of the system to this process. Having these scientists work directly with their data is preferable, compared to outsourcing data analysis to bioinformatics scientists not familiar with the system.

While AI has made drastic improvements in many areas, we are nowhere near its application in science, where the goal is to discover novel interactions, drugs, etc. In other words, the job of software in scientific research is not to provide answers directly, but rather to assist scientists in allowing them to intuitively interact with data and present it to them in the best possible way so that the scientists can come up with answers themselves.

Many existing software packages have inherent restrictions due to design that assumes some pre-conceived organization of data and analysis flows. From the user perspective, some users organize data by lab, others by user, others by researcher, others by project, and still others in different ways. Data analysis needs can be even more diverse than that.

There are a number of platforms, free and commercial, which are targeted for Life Sciences, including platforms (Galaxy) and workflow managers (Cromwell), but those are not geared towards allowing scientists to natively and intuitively interact with data. Existing platforms skills in coding and bioinformatics for effective use. Bioinformaticians may have those skills, but are not familiar with the systems scientists have specialized in, and therefore do not have in-depth understanding of what is important and what is not. In addition, the existing platforms are very structured and require data and experiment designs to exist in a limited number of possibilities. In addition, many current analysis pipelines take input data and produce results, graphed or as a list or table after many steps which are, for the most part, a black box and not understood well by people using them. This does not allow for scientists to view and interact with the data from start to finish.

What is desired are systems that allow scientists to intuitively manipulate and visualize bioinformatics data in ways that do not require writing code or other expertise in bioinformatics or data analysis.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In some embodiments, a system for processing life science information is provided. The system includes a file data store and an intuitive processing computing system. The file data store is configured to store a plurality of files, and each file of the plurality of files is associated with one or more tags. The intuitive processing computing system is configured to provide an object definition data store, an action definition data store, an object retrieval engine, and an action execution engine. The object definition data store is configured to store a plurality of object definitions. The action definition data store is configured to store a plurality of action definitions. The object retrieval engine is configured to retrieve files from the file data store that are identified by a given object definition. The action execution engine is configured to perform an action defined by an action definition on one or more files retrieved from the file data store that are identified by a given object definition.

In some embodiments, a method for processing life science information is provided. A plurality of files are stored in a file data store. Each file of the plurality of files is associated with one or more tags. A plurality of object definitions and a plurality of action definitions are stored. A selection of an object definition of the plurality of object definitions is received. One or more files are retrieved from the file data store that are identified by the selected object definition. A selection of an action definition of the plurality of action definitions is received. An action defined by the selected action definition is performed on the one or more files retrieved from the file data store.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram that illustrates a non-limiting example embodiment of a system according to various aspects of the present disclosure.

FIG. 2 is a block diagram that illustrates a non-limiting example embodiment of an intuitive processing computing system according to various aspects of the present disclosure.

FIG. 3 is a block diagram that illustrates a non-limiting example embodiment of a computing device appropriate for use as a computing device with embodiments of the present disclosure.

FIG. 4A, FIG. 4B, and FIG. 4C illustrate non-limiting examples of a representation of a file, an object definition, and an action definition, respectively, as used by embodiments of the present disclosure.

FIG. 5A-FIG. 5B are a flowchart that illustrates a method of intuitive processing of life sciences information via a graphical user interface according to various aspects of the present disclosure.

### DETAILED DESCRIPTION

In some embodiments of the present disclosure, unique techniques are provided comprising a set of tools for data management, storage, visualization, processing and analysis for the field of life sciences. These tools are designed to allow scientists to intuitively interact with data and get their work done.

In some embodiments, a framework based on a microservices architecture is provided. In some embodiments, this framework may be optimized to operate on Amazon Web services (AWS) or another cloud computing system. In some embodiments, the microservices include a set of tools to organize, manipulate, analyze and visualize data used in life science research. These tools allow scientists to manage digital files in an intuitive manner by associating files and actions that can be applied to them with one or more tags.

Selecting one or more objects and/or actions that contain matching tag vectors can be used to start an analysis, visualization, or other processing. There is no inherent hierarchy in the system, just a collection of files and actions that are associated with tags. By specifying tags and tag rules, some embodiments of the present disclosure allow scientists to intuitively interact with data by suggesting what can be done with each data set that is selected. This can also be used to compare datasets that share tags. By selecting different objects, some embodiments of the present disclosure will present common tags/visualizations/operations that may be performed.

The framework is designed to be very flexible. In some embodiments, a user interface is provided that allows a user to select an object from a list of stored object definitions, select an action from a list of stored action definitions valid for the selected object, and generate the result of executing the action on the object (files that are associated with the tags and/or tag values specified in the object definition). In some embodiments, additional objects may be added by creating additional stored object definitions, and additional actions may be added by creating additional action definitions.

In some embodiments, objects may also be used when search across the system is performed. Results may be grouped per object and presented to the user for finding things quickly. For instance, global search for a string such as “biomarker” can return results in files, analyses, tags, pipeline results, etc. Users (scientists) can organize, fetch, search data based on objects that are defined by tags. This allows for easy grouping and organizing seemingly different data.

The concept of tag-defined objects may extend to the data analysis as well. An analysis itself is an object which contains input data, with given parameters, available visualizations and actions to further transform it. Other objects can be generated inside the analysis object, depending on the configuration. By defining tags and object creation rules, the same framework can be used in myriad of different situations, workflows, experimental designs, etc. Furthermore, objects can have similar/compatible components which can be used to compare objects that are otherwise very different. This would be achieved when data in objects can be for instance compatible with the same visualizations. For example, if an object file and an object result are generated, but both objects support histogram visualization, a user may select to compare objects and view both using histogram visualizations.

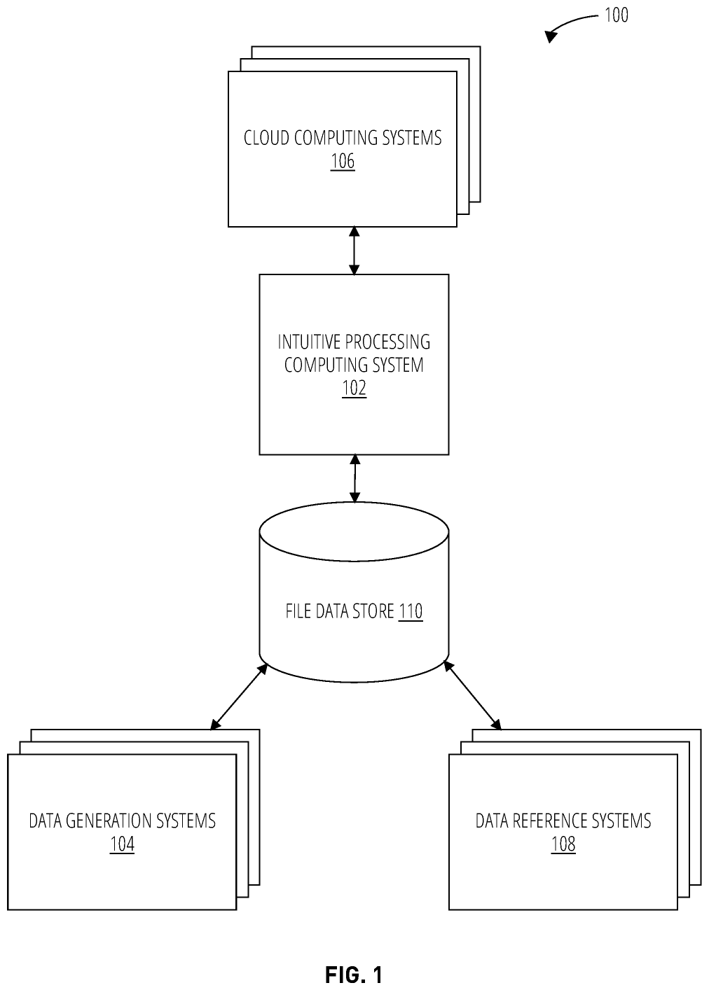

FIG. 1 is a block diagram that illustrates a non-limiting example embodiment of a system according to various aspects of the present disclosure. As shown, one or more data generation systems 104 generate life sciences data, and store files containing the data (or references to files containing the data) in a file data store 110. Data (or references to data) from one or more data reference systems 108 may also be stored in the file data store 110. The intuitive processing computing system 102 organizes the life sciences data in the file data store 110 as described in further detail below, making it intuitively manipulable via one or more user interfaces generated by the intuitive processing computing system 102.

Once manipulation and/or visualization instructions are received by the intuitive processing computing system 102, the intuitive processing computing system 102 may use one or more cloud computing systems 106 to manipulate and/or visualize the life sciences data. In some embodiments, the manipulations and/or visualizations may be provided by microservices hosted by the cloud computing systems 106. In some embodiments, portions of the intuitive processing computing system 102 may also be provided as microservices hosted by one or more cloud computing systems 106.

The data generation systems 104 may include any type of systems that generate life sciences information. Some examples of data generation systems 104 include, but are not limited to, sequencing devices (such as DNA sequencing systems and RNA sequencing systems); imaging devices (such as microscopes, magnetic resonance imaging (MRI) systems, positron emission tomography (PET) systems, X-ray systems, computed tomography (CT) systems, and ultrasound systems); flow cytometers, mass spectrometers, microfluidic devices (e.g. Fluidigm); PCR machines; and microarray instruments.

The data reference systems 108 may include any type of systems that store reference information usable to process life sciences information generated by data generation systems 104. Some non-limiting examples of data reference systems 108 include systems that store reference genome information, sequence read information, protein structure information, small molecule structure information, and metabolic pathway information.

As used herein, “data store” refers to any suitable device configured to store data for access by a computing device. One example of a data store is a highly reliable, high-speed relational database management system (DBMS) executing on one or more computing devices and accessible over a high-speed network. Another example of a data store is a Hierarchical Data Format (HDF5) store. However, any other suitable storage technique and/or device capable of quickly and reliably providing the stored data in response to queries may be used, and the computing device may be accessible locally instead of over a network, or may be provided as a cloud-based service. A data store may also include data stored in an organized manner on a computer-readable storage medium, such as a hard disk drive, a flash memory, RAM, ROM, or any other type of computer-readable storage medium. One of ordinary skill in the art will recognize that separate data stores described herein may be combined into a single data store, and/or a single data store described herein may be separated into multiple data stores, without departing from the scope of the present disclosure.

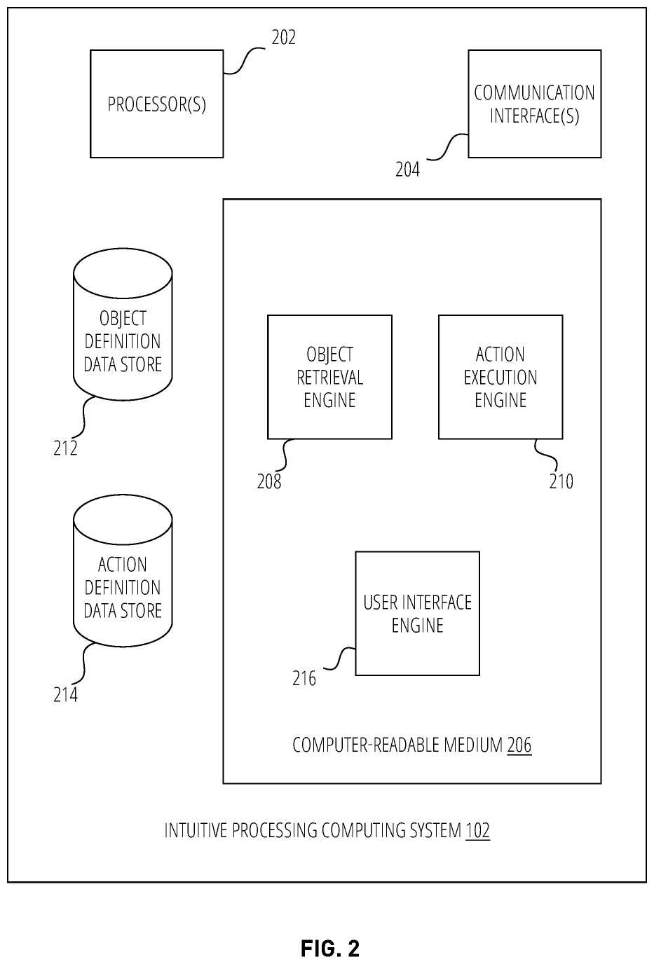

FIG. 2 is a block diagram that illustrates aspects of a non-limiting example embodiment of an intuitive processing computing system according to various aspects of the present disclosure. The illustrated intuitive processing computing system 102 may be implemented by any computing device or collection of computing devices, including but not limited to desktop computing devices, laptop computing devices, mobile computing devices, server computing devices, computing devices of a cloud intuitive processing computing system, and/or combinations thereof.

As shown, the intuitive processing computing system 102 includes one or more processors 202, one or more communication interfaces 204, an object definition data store 212, an action definition data store 214, and a computer-readable medium 206.

In some embodiments, the processors 202 may include any suitable type of general-purpose computer processor. In some embodiments, the processors 202 may include one or more special-purpose computer processors or AI accelerators optimized for specific computing tasks, including but not limited to graphical processing units (GPUs), vision processing units (VPTs), and tensor processing units (TPUs).

In some embodiments, the communication interfaces 204 include one or more hardware and or software interfaces suitable for providing communication links between components. The communication interfaces 204 may support one or more wired communication technologies (including but not limited to Ethernet, FireWire, and USB), one or more wireless communication technologies (including but not limited to Wi-Fi, WiMAX, Bluetooth, 2G, 3G, 4G, 5G, and LTE), and/or combinations thereof.

As shown, the computer-readable medium 206 has stored thereon logic that, in response to execution by the one or more processors 202, cause the intuitive processing computing system 102 to provide an object retrieval engine 208, an action execution engine 210, and a user interface engine 216.

As used herein, “computer-readable medium” refers to a removable or nonremovable device that implements any technology capable of storing information in a volatile or non-volatile manner to be read by a processor of a computing device, including but not limited to: a hard drive; a flash memory; a solid state drive; random-access memory (RAM); read-only memory (ROM); a CD-ROM, a DVD, or other disk storage; a magnetic cassette; a magnetic tape; and a magnetic disk storage.

In some embodiments, the object retrieval engine 208 is configured to retrieve objects from the file data store 110. As discussed in further detail below, objects are files that are associated with specific tags and/or tag values as defined in an object definition stored in the object definition data store 212. In some embodiments, the action execution engine 210 is configured to process objects based on action definitions stored in the action definition data store 214. In some embodiments, the user interface engine 216 is configured to present user interfaces to users to allow users to associate objects (defined by object definitions in the object definition data store 212) with actions (defined by action definitions stored in the action definition data store 214), and to thereby manipulate and/or visualize file data stored in the file data store 110 in an intuitive manner.

Further description of the configuration of each of these components is provided below.

As used herein, “engine” refers to logic embodied in hardware or software instructions, which can be written in one or more programming languages, including but not limited to C, C++, C#, COBOL, JAVA™, PHP, Perl, HTML, CSS, JavaScript, VBScript, ASPX, Go, and Python. An engine may be compiled into executable programs or written in interpreted programming languages. Software engines may be callable from other engines or from themselves. Generally, the engines described herein refer to logical modules that can be merged with other engines, or can be divided into sub-engines. The engines can be implemented by logic stored in any type of computer-readable medium or computer storage device and be stored on and executed by one or more general purpose computers, thus creating a special purpose computer configured to provide the engine or the functionality thereof. The engines can be implemented by logic programmed into an application-specific integrated circuit (ASIC), a field-programmable gate array (FPGA), or another hardware device.

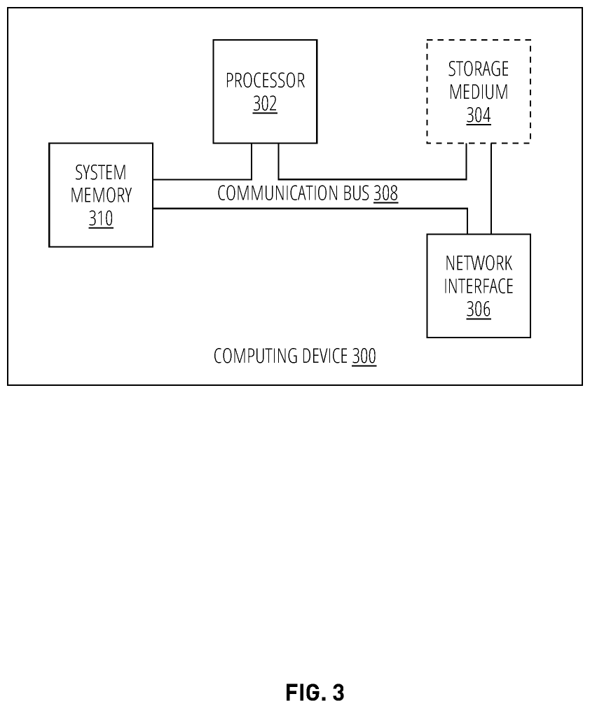

FIG. 3 is a block diagram that illustrates aspects of a non-limiting example of a computing device 300 appropriate for use as a computing device of the present disclosure. The intuitive processing computing system 102 and other components of the system 100 may be formed from one or more computing devices such as the illustrated computing device 300.

While multiple different types of computing devices were discussed above, the exemplary computing device 300 describes various elements that are common to many different types of computing devices. While FIG. 3 is described with reference to a computing device that is implemented as a device on a network, the description below is applicable to servers, personal computers, mobile phones, smart phones, tablet computers, embedded computing devices, and other devices that may be used to implement portions of embodiments of the present disclosure. Some embodiments of a computing device may be implemented in or may include an application-specific integrated circuit (ASIC), a field-programmable gate array (FPGA), or other customized device. Moreover, those of ordinary skill in the art and others will recognize that the computing device 300 may be any one of any number of currently available or yet to be developed devices.

In its most basic configuration, the computing device 300 includes at least one processor 302 and a system memory 310 connected by a communication bus 308. Depending on the exact configuration and type of device, the system memory 310 may be volatile or nonvolatile memory, such as read only memory (“ROM”), random access memory (“RAM”), EEPROM, flash memory, or similar memory technology. Those of ordinary skill in the art and others will recognize that system memory 310 typically stores data and/or program modules that are immediately accessible to and/or currently being operated on by the processor 302. In this regard, the processor 302 may serve as a computational center of the computing device 300 by supporting the execution of instructions.

As further illustrated in FIG. 3, the computing device 300 may include a network interface 306 comprising one or more components for communicating with other devices over a network. Embodiments of the present disclosure may access basic services that utilize the network interface 306 to perform communications using common network protocols. The network interface 306 may also include a wireless network interface configured to communicate via one or more wireless communication protocols, such as Wi-Fi, 2G, 3G, LTE, WiMAX, Bluetooth, Bluetooth low energy, and/or the like. As will be appreciated by one of ordinary skill in the art, the network interface 306 illustrated in FIG. 3 may represent one or more wireless interfaces or physical communication interfaces described and illustrated above with respect to particular components of the computing device 300.

In the exemplary embodiment depicted in FIG. 3, the computing device 300 also includes a storage medium 304. However, services may be accessed using a computing device that does not include means for persisting data to a local storage medium. Therefore, the storage medium 304 depicted in FIG. 3 is represented with a dashed line to indicate that the storage medium 304 is optional. In any event, the storage medium 304 may be volatile or nonvolatile, removable or nonremovable, implemented using any technology capable of storing information such as, but not limited to, a hard drive, solid state drive, CD ROM, DVD, or other disk storage, magnetic cassettes, magnetic tape, magnetic disk storage, and/or the like.

Suitable implementations of computing devices that include a processor 302, system memory 310, communication bus 308, storage medium 304, and network interface 306 are known and commercially available. For ease of illustration and because it is not important for an understanding of the claimed subject matter, FIG. 3 does not show some of the typical components of many computing devices. In this regard, the computing device 300 may include input devices, such as a keyboard, keypad, mouse, microphone, touch input device, touch screen, tablet, and/or the like. Such input devices may be coupled to the computing device 300 by wired or wireless connections including RF, infrared, serial, parallel, Bluetooth, Bluetooth low energy, USB, or other suitable connections protocols using wireless or physical connections. Similarly, the computing device 300 may also include output devices such as a display, speakers, printer, etc. Since these devices are well known in the art, they are not illustrated or described further herein.

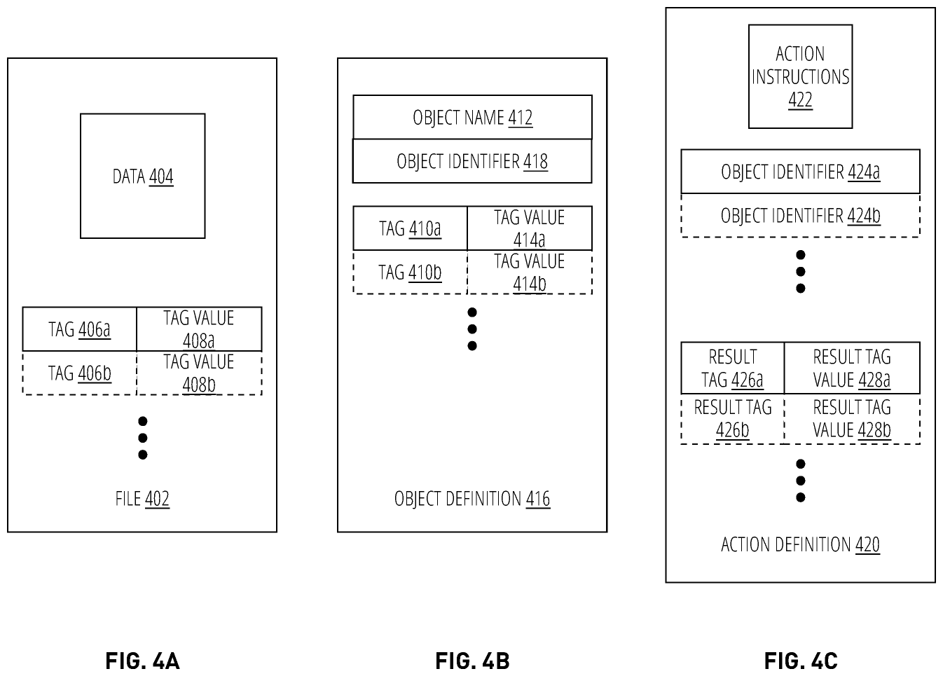

FIG. 4A, FIG. 4B, and FIG. 4C illustrate non-limiting examples of a representation of a file, an object definition, and an action definition, respectively, as used by embodiments of the present disclosure.

At a high level, the system 100 makes the manipulation and/or visualization of life sciences data intuitive by abstracting life sciences data into objects. Life sciences data is stored in files, and files are associated with tags and tag values. Objects are defined by identifying tags and/or tag values that are associated with the object, and actions are defined by reference to what objects they are designed to manipulate.

FIG. 4A is a non-limiting example of how a file 402 may be represented within the system 100 according to various aspects of the present disclosure. As illustrated, the file 402 includes data 404, one or more tags 406a-406b, and one or more tag values 408a-408b. The tag 406b and tag value 408b are illustrated as optional because in some embodiments the file 402 may include only a single tag 406a/tag value 408a.

In some embodiments, the tag indicates a type of data (e.g., a file name, a data generation system that generated the data 404, a date, a format, etc.), and the tag value associated with the tag includes a value for the type of data (e.g., the actual file name, a name or an identifier of the data generation system that generated the data 404, the date associated with the file 402, the format of the file 402, etc.).

In some embodiments, the data 404 is the actual data generated by the data generation system, and is stored in the file 402 in the file data store 110. In some embodiments, the data 404 may be a URL or other reference to the actual data generated by the data generation system, which may be stored on a separate system such as a network share, a removable computer-readable medium, a cloud storage system, or in any other location accessible by the intuitive processing computing system 102. In some embodiments, the data 404 may be a URL or other reference to data stored in a public reference database (such as one or more data reference systems 108), or data copied from one or more data reference systems 108 and stored in another location (such as the file data store 110).

FIG. 4B is a non-limiting example of how an object may be represented within the system 100 according to various aspects of the present disclosure. The object definition 416 abstracts access to files stored in the file data store 110, which may be retrieved as objects according to object definitions 416.

As illustrated, an object is defined by an object definition 416 that includes an object name 412, an object identifier 418, one or more tags 410a-410b, and one or more tag values 414a-414b. The tag 410b and tag value 414b are illustrated as optional because in some embodiments the object definition 416 may include only a single tag 410a/tag value 414a. In some embodiments, the object name 412 is a human-readable identifier for the object definition 416 that may be presented by the user interface engine 216 for a user to select objects defined by the object definition 416. In some embodiments, the object identifier 418 is a unique identifier that may be used to link the object definition 416 to one or more action definitions 420 as discussed in further detail below.

In some embodiments, the tags 410a-410b and tag values 414a-414b of the object definition 416 may specify files that may be retrieved as the object by indicating certain tag and/or tag value combinations to be present in the file 402 for the file 402 to be considered an instance of (or part of an instance of) the object. In some embodiments, the object definition 416 may indicate additional information not shown in FIG. 4B, including but not limited to object properties (a type or number of files to be included, etc.), allowed actions that can be applied to the object, computer-executable instructions that provide procedures for storing and access data 404 from the associated files 402, and computer-executable instructions for visualization of the object.

Objects may represent single files to be used as input for actions, multiple different files to be used jointly as input for actions, results of analysis (list of important genes, etc.), or for other purposes. In some embodiments, objects may be organized into a hierarchy for browsing and/or other organization.

FIG. 4C is a non-limiting example of how an action may be represented within the system 100 according to various aspects of the present disclosure. The action definition 420 defines an action (e.g., manipulation and/or visualization) that may be applied to one or more objects, thus simplifying the processing of data 404.

As illustrated, an action is defined by an action definition 420 that includes action instructions 422, one or more object identifiers 424a-424b, one or more result tags 426a-426b, and one or more result tag values result tag value 428a-428b. The one or more object identifiers 424a-424b link the action definition 420 to one or more object definitions 416. The linked object definitions 416 are used to retrieve files 402 from the file data store 110, and the action instructions 422 are then used to process the data 404 of the files 402. Results of executing the action instructions 422 may be stored as a file 402 in the file data store 110, and may be tagged with the result tags 426a-426b and result tag values 428a-428b.

The object identifier 424b is illustrated as optional because in some embodiments the action definition 420 may include only a single object identifier 424a. Likewise, the result tag 426b and result tag value 428b are illustrated as optional because in some embodiments the action definition 420 may include only a single result tag 426a and result tag value 428a.

The action instructions 422 include computer-executable instructions that may be used to manipulate and/or visualize data 404 of files 402 of associated objects. In some embodiments, the action instructions 422 may themselves be executed by the intuitive processing computing system 102, or may be provided by the intuitive processing computing system 102 to one or more cloud computing systems 106 for execution. In some embodiments, the action instructions 422 may include indications of application programming interface (API) endpoints that may be used to manipulate and/or visualize the data 404 (as opposed to the actual computer-executable instructions to be executed).

In some embodiments, several types of tags may be used for the files 402, object definitions 416, and action definitions 420. As one example, annotation tags may be free form tags (any text) or attribute tags (a named column containing text or values). Some common examples of annotation tags may include, but are not limited to, file type, file origin, username, file size, version, clinical phenotype, etc. As another example, data property (properties) tags may describe data that objects contains (e.g. vector) which determines which visualization(s) or operations can be used on that object (e.g. for objects that have matrix values, we can use heatmap, box plots, etc.).

Based on the tags (and/or values stored in these tags), one can construct and define objects by tag or collection of tags. For instance, an object definition 416 can specify tags NGS and RNASeq in order to retrieve relevant files 402 from the file data store 110 for manipulation and/or visualization of sequencing data. The action instructions 422 of an action definition 420 using that object definition 416 can have specific rules to process these on load through FASTQC program and through an NGS pipeline of choice. This would generate FASTQC results and expression values, which may be stored as a file 402 in the file data store 110 that may then be retrieved by another object definition 416 and visualized and/or manipulated using another action definition 420.

In some embodiments, object definitions 416 may include some features of action definitions 420, such that an object may automatically process data 404 from a file 402 upon retrieval from the file data store 110. For example, the action instructions 422 described in the preceding paragraph (wherein NGS and RNASeq data is processed through FASTQC and an NGS pipeline) may be included in an object definition 416, such that the retrieval and processing of the data 404 is performed in a single step within the system 100, and the contents of the files 402 are simplified even further for presentation in the user interface.

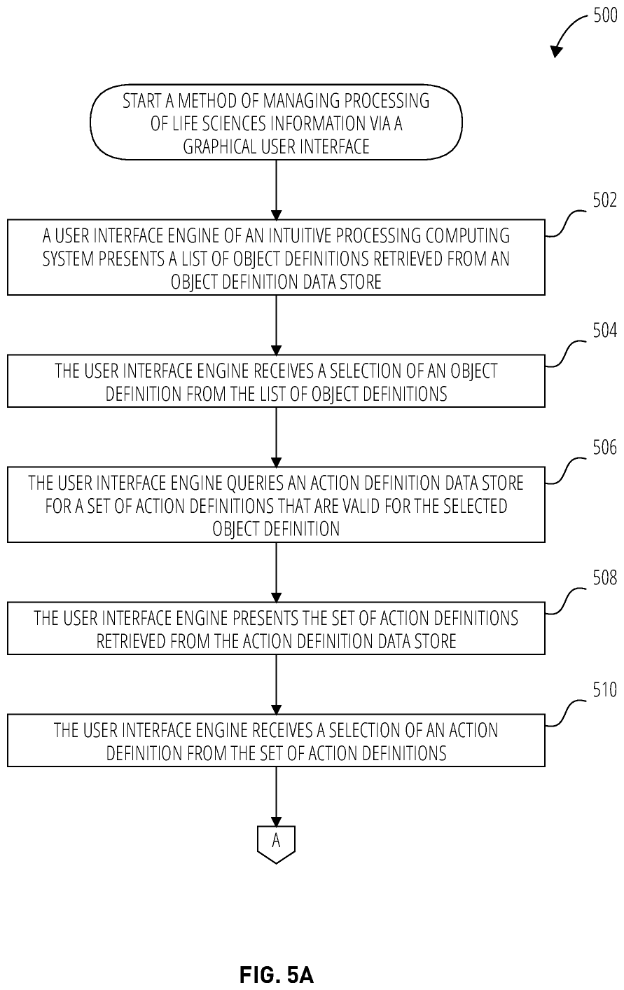

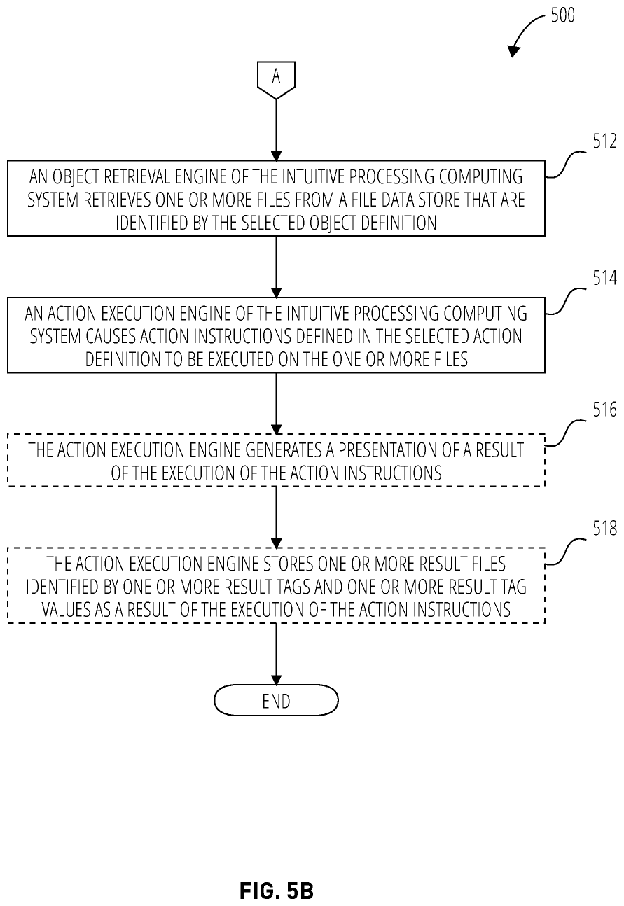

FIG. 5A-FIG. 5B are a flowchart that illustrates a method of intuitive processing of life sciences information via a graphical user interface according to various aspects of the present disclosure. By using the system 100 illustrated above, the method 500 provides technical improvements beyond those present in the prior art, at least because the novel user interface and the processing it controls allows scientists without programming skills to organize and conduct complex manipulations and visualizations of data 404 in ways that were not previously possible without having coding and other technical skills.

From a start block, the method 500 proceeds to block 502, where a user interface engine 216 of an intuitive processing computing system 102 presents a list of object definitions 416 retrieved from an object definition data store 212. For each object definition 416 managed by the intuitive processing computing system 102, a new tab (view) may be presented and users can search, group or manage those object definitions 416. In some embodiments, object definitions 416 containing vector or matrix data and containing common tags may be selected together and new type of object definition 416—a dataset—may be created. The dataset will have combined data from all member object definitions 416, and may aggregate tag information from the member object definitions 416.

At block 504, the user interface engine 216 receives a selection of an object definition 416 from the list of object definitions 416. The selection may be received via any suitable technique, including but not limited to a click on an object definition 416, dragging an object definition 416 to a “selected” area of the user interface, and a click on a checkbox associated with the object definition 416. In some embodiments, multiple object definitions 416 may be selected.

At block 506, the user interface engine 216 queries an action definition data store 214 for a set of action definitions 420 that are valid for the selected object definition 416. In some embodiments, the valid action definitions 420 may be determined by querying for action definitions 420 that reference the object identifier 418 of the selected object definition 416.

At block 508, the user interface engine 216 presents the set of action definitions 420 retrieved from the action definition data store 214, and at block 510, the user interface engine 216 receives a selection of an action definition 420 from the set of action definitions 420. Again, the selection of the action definition 420 may be received using any suitable technique, including the techniques listed above for the selection of the object definition 416. The presentation of the action definitions 420 may include names, descriptions of processing, samples of visualizations or result outputs, and/or other information associated with each action definition 420 so that the user may intuitively choose between action definitions 420 valid for the selected object definition 416.

One will note that, though FIG. 5A illustrates that a list of object definitions 416 is presented and then a set of action definitions 420 that are valid for a selected object definition 416 is retrieved, this order should not be seen as limiting. For example, in some embodiments, a list of action definitions 420 may be presented first, and then a set of object definitions 416 that are valid for one or more selected action definitions 420 may then be retrieved for presentation to the user.

After block 508, the method 500 proceeds to a continuation terminal (“terminal A”). From terminal A (FIG. 5B), the method 500 proceeds to block 512, where an object retrieval engine 208 of the intuitive processing computing system 102 retrieves one or more files 402 from a file data store 110 that are identified by the selected object definition 416. The files 402 are identified by having tags and/or tag values that match the tags and/or tag values of the selected object definition 416. Upon retrieval, the file 402 constitute an instance of the object defined by the selected object definition 416. In some embodiments, the user interface may allow the user to select from multiple files 402 stored in the file data store 110 that match the selected object definition 416 (in other words, from multiple objects of the same type as defined by the selected object definition 416 as stored in the file data store 110). In some embodiments, the user interface may not allow the user to select from multiple matching files 402, and may instead process all matching files 402.

At block 514, an action execution engine 210 of the intuitive processing computing system 102 causes action instructions 422 defined in the selected action definition 420 to be executed on the one or more files 402. As stated above, the intuitive processing computing system 102 may itself execute the action instructions 422 on the data 404 in the files 402, or may use the action instructions 422 to transmit the data 404 in the files 402 to another system (such as one or more cloud computing systems 106) for processing.

At optional block 516, the action execution engine 210 generates a presentation of a result of the execution of the action instructions 422, and at optional block 518, the action execution engine 210 stores one or more result files identified by one or more result tags 426a-426b and one or more result tag values 428a-428b as a result of the execution of the action instructions 422. Optional block 516 and optional block 518 are illustrated as optional because in some embodiments, the action definition 420 may specify only one of a visualization/presentation and a manipulation/result file generation. Some examples of manipulation/result file generations include, but are not limited to, scaling, normalization, log transformation, ratio, statistical testing, pathway enrichment calculations, linear mixed model calculations, image analysis and feature detection, grouping of peaks into isotopes, grouping of peptides into proteins, and grouping of probes into genes. Some examples of visualizations include, but are not limited to, box plots, histograms, line graphs, bar graphs, violin plots, volcano plots, density graphs, heat maps, clustered heat maps, pathway visualizations, contour and dot plots for flow cytometry data, real time PCR data graphs, survival curve graphs, Venn diagrams, pie charts, area graphs, scatter plots, spline charts, bubble charts, and any type of visualization overlayed on top of an image.

The method 500 then proceeds to an end block and terminates.

While illustrative embodiments have been illustrated and described, it will be appreciated that various changes can be made therein without departing from the spirit and scope of the invention.

The embodiments of the invention in which an exclusive property or privilege is claimed are defined as follows:

1. A system for processing life science information, the system comprising:
a file data store configured to store a plurality of files, wherein each file of the plurality of files is associated with one or more tags; and
an intuitive processing computing system configured to provide:
an object definition data store configured to store a plurality of object definitions;
an action definition data store configured to store a plurality of action definitions;
an object retrieval engine configured to retrieve files from the file data store that are identified by a given object definition; and
an action execution engine configured to perform an action defined by an action definition on one or more files retrieved from the file data store that are identified by a given object definition.

2. The system of claim 1, wherein each tag of the one or more tags includes at least one tag value; and
wherein each object definition in the plurality of object definitions includes one or more tag values for the one or more tags.

3. The system of claim 2, wherein retrieving files from the file data store that are identified by a given object definition includes:
determining one or more tag values for one or more tags associated with the given object definition; and
retrieving files from the file data store that are associated with the one or more tags having the one or more tag values.

4. The system of claim 1, wherein each action definition includes:
indications of one or more object definitions for which the action definition is valid; and
a set of computer-executable instructions that, in response to execution by one or more processors of a computing device, cause the computing device to perform specific tasks using one or more files retrieved using an object definition of the one or more object definitions for which the action definition is valid.

5. The system of claim 4, wherein performing the action defined by the action definition on one or more files retrieved from the file data store that are identified by the given object definition includes:
executing the set of computer-executable instructions included in the action definition to process the one or more files retrieved from the file data store to generate an action result.

6. The system of claim 5, wherein generating the action result includes generating a presentation of information stored in the one or more files.

7. The system of claim 5, wherein generating the action result includes transforming the information stored in the one or more files to generate one or more result files.

8. The system of claim 7, wherein the action definition further includes one or more result tag values for one or more tags to be associated with the one or more result files.

9. The system of claim 8, wherein generating the action result further includes storing the one or more result files in the file data store along with the one or more result tag values for the one or more tags.

10. The system of claim 4, further comprising a user interface engine configured to:
present a list of objects associated with object definitions stored in the object definition data store;
receive a selection of an object from the list of objects; and
present a list of actions associated with action definitions stored in the action definition data store, wherein the action definitions include indications that the action definition is valid for the object definition associated with the object.

11. A method for processing life science information, the method comprising:
storing a plurality of files in a file data store, wherein each file of the plurality of files is associated with one or more tags;
storing a plurality of object definitions;
storing a plurality of action definitions;
receiving a selection of an object definition of the plurality of object definitions;
retrieving one or more files from the file data store that are identified by the selected object definition;
receiving a selection of an action definition of the plurality of action definitions; and
performing an action defined by the selected action definition on the one or more files retrieved from the file data store.

12. The method of claim 11, wherein each tag of the one or more tags includes at least one tag value; and
wherein each object definition in the plurality of object definitions includes one or more tag values for one or more tags.

13. The method of claim 12, wherein retrieving one or more files from the file data store that are identified by the selected object definition includes:
determining one or more tag values for one or more tags associated with the given object definition; and
retrieving one or more files from the file data store that are associated with the one or more tags having the one or more tag values.

14. The method of claim 11, wherein each action definition includes:
indications of one or more object definitions for which the action definition is valid; and
a set of computer-executable instructions that, in response to execution by one or more processors of a computing device, cause the computing device to perform specific tasks using one or more files retrieved using an object definition of the one or more object definitions for which the action definition is valid.

15. The method of claim 14, wherein performing the action defined by the selected action definition on the one or more files retrieved from the file data store includes:
executing the set of computer-executable instructions included in the action definition to process the one or more files retrieved from the file data store to generate an action result.

16. The method of claim 15, wherein generating the action result includes generating a presentation of information stored in the one or more files.

17. The method of claim 15, wherein generating the action result includes transforming the information stored in the one or more files to generate one or more result files.

18. The method of claim 17, wherein the action definition further includes one or more result tag values for one or more tags to be associated with the one or more result files.

19. The method of claim 18, further comprising storing the one or more result files in the file data store along with the one or more result tag values for the one or more tags.

20. The method of claim 14, further comprising:
presenting a list of objects associated with stored object definitions; and
presenting a list of actions associated with stored action definitions, wherein the stored action definitions include indications that the action definition is valid for the object definition associated with the selected object.
